(19) United States
(12) Patent Application Publication
(10) Pub. No.: US 2009/0005024 A1
(43) Pub. Date: Jan. 1, 2009

(54) CELL PHONE AND INCOMING CALL FORWARDING METHOD

(75) Inventor: Ayako KATO, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION, Tokyo (JP)

(21) Appl. No.: 12/163,534

(22) Filed: Jun. 27, 2008

(30) Foreign Application Priority Data
Jun. 29, 2007 (JP) 172129/2007

(51) Int. Cl. H04M 3/42; H04M 1/00

(52) U.S. Cl. 455/417; 455/550.1

(57) ABSTRACT

A cell phone includes a first communication unit configured to communicate with other cell phones via a base station, a second communication unit configured to communicate directly with other cell phones located within a predetermined distance, and a controller, wherein, the controller stores a list including an identifier of a candidate cell phone for a forwarding destination of a connection request signal for requesting a communication connection, and if the controller receives the connection request signal via the first communication unit and then a user does not respond within a predetermined time or if a forwarding instruction is provided from a sender of the connection request signal, the controller conducts a search to see whether another cell phone having an identifier included in the list is located within the predetermined distance via the second communication unit, and if the controller finds the another cell phone having an identifier included in the list, the controller instructs, via the first communication unit, the base station to forward the connection request signal to the another cell phone.

This application is based upon and claims the benefit of priority from Japanese patent application No. 2007-172129, filed on Jun. 29, 2007, the disclosure of which is incorporated herein in its entirety by reference.

### BACKGROUND OF THE INVENTION

1. Field of the Invention

The present invention relates to a cell phone and an incoming call forwarding method.

2. Description of the Related Art

Services for forwarding an incoming call to a fixed phone at home to a cell phone, have been provided. However, even if the user of a cell phone uses such a service and an incoming call is forwarded to the cell phone, the user may not be able to take the call. For this reason, there has been disclosed a technology for allowing a caller to notify a user's cell phone of the caller's phone number using an email rather than forwarding an incoming call to the user's cell phone (see Japanese Patent Application Publication No. 2003-046663). This allows the user to see the caller's phone number included in the email and call back the caller when the user has a situation in which the user can place a call.

There are cell phones having a Bluetooth (registered trademark) function (see Japanese Patent Application Publication No. 2002-319887). Also, there is a case where both a cell phone and a hands-free terminal have a Bluetooth (registered trademark) function in order to make a phone conversation during driving possible.

According to the technology described above, if the cell phone user cannot take an incoming call to the cell phone, the user is notified of the caller's phone number. However, the caller is not sure when the user will call back the caller. Therefore, it is inconvenient when the caller wants to make contact with the user immediately.

For example, when multiple members go for a drive in a manner that the members ride in multiple cars separately, the following problem may occur. That is, the multiple members are divided into groups according to the number of cars before driving. During driving, a member who is riding in the second or later car from the leading car comes to want to take a rest and places a call to the cell phone of the driver of the leading car. If the driver does not get aware of the incoming call to the driver's cell phone, the driver continues to drive the car. Even if the driver gets aware of the incoming call, the driver cannot take the call unless the leading car is equipped with a hands-free terminal. As a result, the member who has placed the call may miss a place where the member wants to take a rest, before the driver finds a place where the driver can stop the car in order to call back on the basis of an incoming call history.

Such a problem does not occur only if a member attempts to make contact with another member to take a rest when driving on a public road. For example, if a member, who is riding in the second or later car, comes to want to change the route to the destination, the leading car may pass through an intersection for changing the route before the member lets the driver of the leading car know that the member wants the driver to make a right or left turn at the intersection. Also, for example, if a member, who is riding in the second or later car, comes to want to get off a highway into a public road when the group is driving on the highway, the leading car may pass through an exit where the member wants to get off the highway before the member lets the driver of the leading car know the exit.

The above-described problems may be solved if the member, who is riding in the second or later car, places a call to another member, who rides in the leading car but is not the driver of the leading car, to communicate the member's intention to the another member so that the passenger may communicate the member's intention to the driver. However, if there are many cars, the member does not have an idea about who is riding in which car and thus must place a call at a guess. As a result, if it takes time before the member reaches any member riding in the leading car by phone, a problem as described above occurs.

### SUMMARY

An exemplary object of the present invention is to solve the above-described problems that the related arts have and to provide a cell phone and an incoming call forwarding method that each allow a caller to notify a person, who cannot take an incoming call, of the caller's intention via another person.

A cell phone according to the present invention for achieving the above-described object includes: a first communication unit configured to communicate with other cell phone via a base station; a second communication unit configured to communicate directly with other cell phones located within a predetermined distance; and a controller. The controller stores a list including an identifier of a candidate cell phone for a forwarding destination of a connection request signal for requesting a communication connection. If a user does not respond within a predetermined time or a forwarding instruction is provided from a sender of the connection request signal after the connection request signal is received via the first communication unit, the controller conducts a search to see whether another cell phone having the identifier included in the list is located within the predetermined distance via the second communication unit. If the controller finds another cell phone having the identifier included in the list, the controller instructs the base station to forward the connection request signal to the another cell phone, which has been found, via the first communication unit.

### BRIEF DESCRIPTION OF THE DRAWINGS

FIG. 1 is a block diagram showing one example configuration of a cell phone according to a first exemplary embodiment;

FIG. 2 is a diagram showing operations performed when a terminal, receiving an incoming call, forwards the call to another terminal, among the multiple cell phones according to the first exemplary embodiment;

FIG. 3 is a flowchart showing operation steps performed by the cell phone according to the first exemplary embodiment; and

FIG. 4 is a block diagram showing an example configuration of a cell phone according to a second exemplary embodiment.

### EXEMPLARY EMBODIMENTS

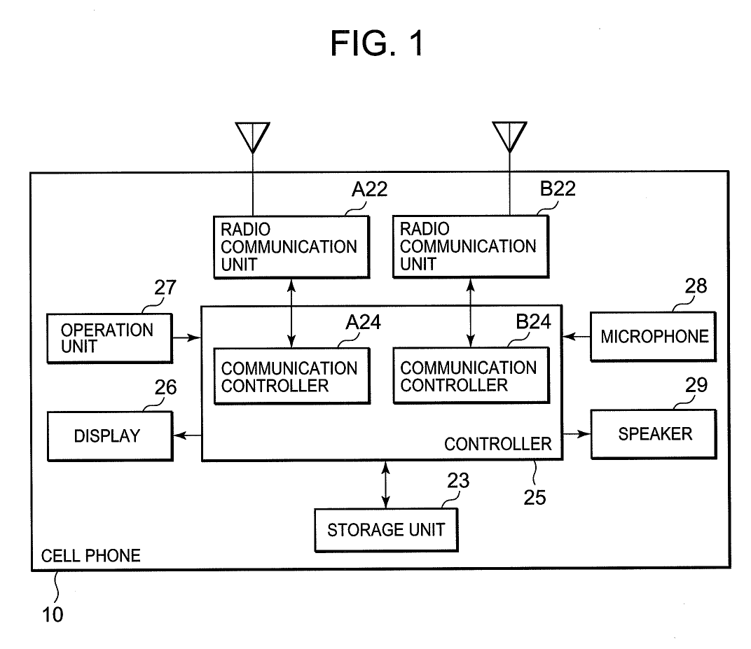

Now a configuration of a cell phone of a first exemplary embodiment will be described. FIG. 1 is a block diagram showing one example configuration of the cell phone according to this exemplary embodiment.

As shown in FIG. 1, a cell phone 10 includes a radio communication unit A22 for communicating with other terminals via a base station, a radio communication unit B22 for directly communicating with another terminal, a storage unit 23, and a controller 25. The cell phone 10 also includes a display 26 for displaying a message to a user, an operation unit 27 with which a user inputs an instruction, a microphone 28, and a speaker 29.

A radio communication unit B22 is a unit to conduct direct communication with another terminal. An example of standards for the radio communication unit B22 is Bluetooth (registered trademark).

The storage unit 23 stores a phonebook specific to the user. The phonebook stores an entry including information such as a name and a phone number. The phone number serves as an identifier for corresponding cell phone. Hereafter, the identifier of a cell phone will be referred to as a “terminal identifier.” Each entry may include information such as a zip code and a street address, like a phonebook included in a common cell phone.

With regard to the phonebook according to this exemplary embodiment, each entry includes a field for specifying the entry as a forwarding destination of an incoming call. This field will be referred to as a “forwarding specification field.” When a phone number is specified as a forwarding destination, a mark to indicate that the phone number is specified as a forwarding destination is put in the forwarding specification field of an entry in which the phone number is included. If a phone number is not specified as a forwarding destination, the forwarding specification field of an entry, in which the phone number is included, remains blank.

There is a case where a call may be forwarded to any of predetermined multiple persons. In this case, a plurality of forwarding destinations are regarded as one group, and a group identifier, which is an identifier to identify the group, is put in each of the forwarding specification fields of entries in which phone numbers specified as the forwarding destinations are included. A list of entries including an identical group identifier corresponds to a group member list. A group member list may include at least information concerning a group identifier and the identifier of a cell phone. An example will be described below.

For example, when multiple members go for a drive in a manner that the members ride in multiple cars separately, the multiple members are divided into groups according to the number of cars. The driver of each car cannot take an incoming call during driving, so the driver selects a cell phone of another member, who rides in the same car, as forwarding destinations. Before driving, at least one driver operates the driver's cell phone to set a group identifier “G1” in each of the forwarding specification fields of the entries of members selected as forwarding destinations.

For example, the driver may have a different member riding in the same car on the way to a destination and on the way from the destination. In this case, the driver sets the group identifier “G1” in each of the forwarding specification fields of the entries of members riding in the same car on the way to the destination and sets a group identifier “G2” in each of the forwarding specification fields of the entries of members riding in the same car on the way from the destination. If there exists only one group, the group member list is not required to include a group identifier and may include the information on identifier of the cell phone of a member of the same group.

The controller 25 includes a communication controller A24 for controlling the radio communication unit A22 and a communication controller B24 for controlling the radio communication unit B22. The controller 25 also includes a CPU (central processing unit) (not shown) for performing a given process according to a program and a memory (not shown) for storing the program. When the CPU executes the program, the communication controller A24 and communication controller B24 may be virtually constructed.

Upon receipt of a connection request signal for requesting a communication connection from the base station, the communication controller A24 notifies the user of an incoming call by a vibration caused by a motor (not shown) or a ringing tone from the speaker 29. If the user does not answer within a predetermined time, the communication controller A24 stops the notification. Since the connection request signal includes information on the terminal identifier of the sender of it, the communication controller A24 passes the information on the terminal identifier of the sender of the connection request signal to the communication controller B24.

Upon receipt of the information on the terminal identifier of the sender of the connection request signal from the communication controller A24, the communication controller B24 checks whether the terminal identifier is included in the group member list stored in the storage unit 23. If the terminal identifier received from the communication controller A24 is registered in the group member list, the communication controller B24 transmits notification information including information on the group identifier of a group including the terminal identifier and the terminal identifier of the cell phone 10 and information indicating a request for a response. If the terminal identifier received from the communication controller A24 is not registered in the group member list, the communication controller B24 ends the process without doing anything.

Upon receipt of response information including information on a group identifier and a terminal identifier as a response to the notification information, the communication controller B24 refers to a group member list, whose group identifier corresponds to the group identifier included in the response information, in the storage unit 23. If the communication controller B24 recognizes that the identifier included in the response information is registered in the group member list, it notifies the base station that it specifies the terminal identifier as a forwarding destination of the connection request signal.

On the other hand, upon receipt of notification information from another terminal, the communication controller B24 checks whether a group member list, whose group identifier corresponds to the group identifier included in the notification information, is registered. If such a group member list exists, the communication controller B24 checks whether the terminal identifier included in the notification information is registered in the group member list. If the terminal identifier included in the notification information is registered in the group member list, the communication controller B24 transmits response information, including information on the group identifier and the terminal identifier of the cell phone 10, to the sender of the notification information. If the terminal identifier included in the notification information is not registered in the group member list, the communication controller B24 ends the process without responding to a response request included in the notification information.

Also, the controller 25 converts a voice inputted from the microphone 28 into a digital signal, encodes the digital signal, and transmits the encoded signal to the outside via the radio communication unit A22 or B22. Also, the controller 25 decodes a voice signal received via the radio communication unit A22 or B22 and outputs the decoded voice signal to the speaker 29. These functions for conversation are similar to those of common cell phones and will not be detailed. Also, the controller 25 may include a digital signal processor (DSP) for switching between an analog signal and a digital signal.

The operation unit 27 includes a forwarding instruction key (not shown) for instructing, after placing a call, a cell phone as destination to forward the call as well as an on-hook key, off-hook key, a character input key, and the like. If a caller operates the forwarding instruction key, the caller need not wait while the cell phone as destination continues to notify during a predetermined time. Thus, it is possible for the caller to instruct the cell phone as destination to forward the call earlier. Instead of providing the forwarding instruction key, any existing key may be configured so that a forwarding instruction is provided by performing a predetermined operation on the existing key.

Upon receipt of information on the terminal identifier specifying the forwarding destination of the connection request signal, the base station (not shown) of the cell phone changes the destination of the connection request signal to a cell phone identified by the terminal identifier. The forwarding method performed by the base station is similar to a generally known method and will not be described in detail.

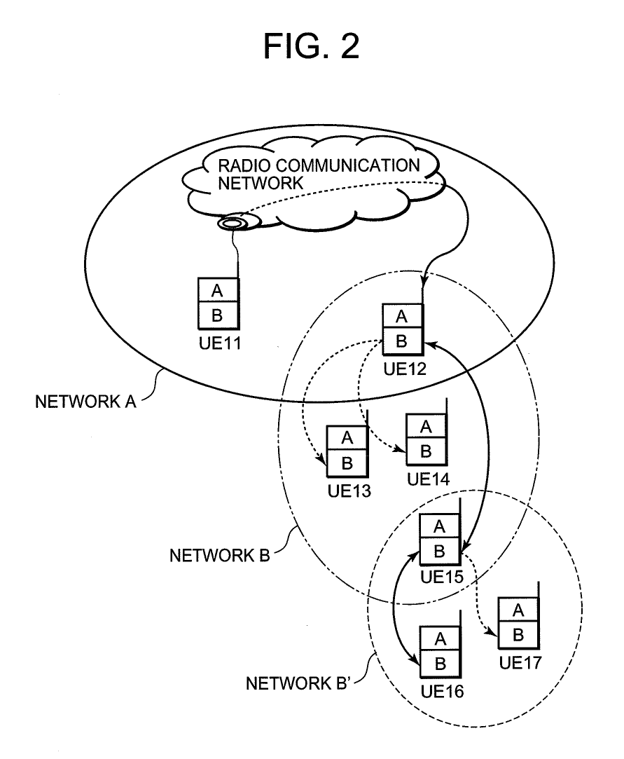

Now, operations of the cell phone shown in FIG. 1 will be described. FIG. 2 is a diagram showing operations performed when a terminal, receiving an incoming call, forwards the call to another terminal, among the multiple cell phones according to this exemplary embodiment. Hereafter, a cell phone will be referred to as an “UE” (user equipment).

FIG. 2 shows the following case: the user of UE 12 does not respond to an incoming call from UE11, UE12 searches for the terminal of a group member being present close to UE12, and if such a terminal is found, as the result of such a search, the call is forwarded to the terminal. Each user previously operates his or her UE to register a group. Thus, the storage unit 23 of each UE stores a group member list including information on a group identifier and the terminal identifier of each UE of the group members. Here, assume that UE11, UE12, UE15, and UE16 are included in the same group and the identifier of this group is represented by G1.

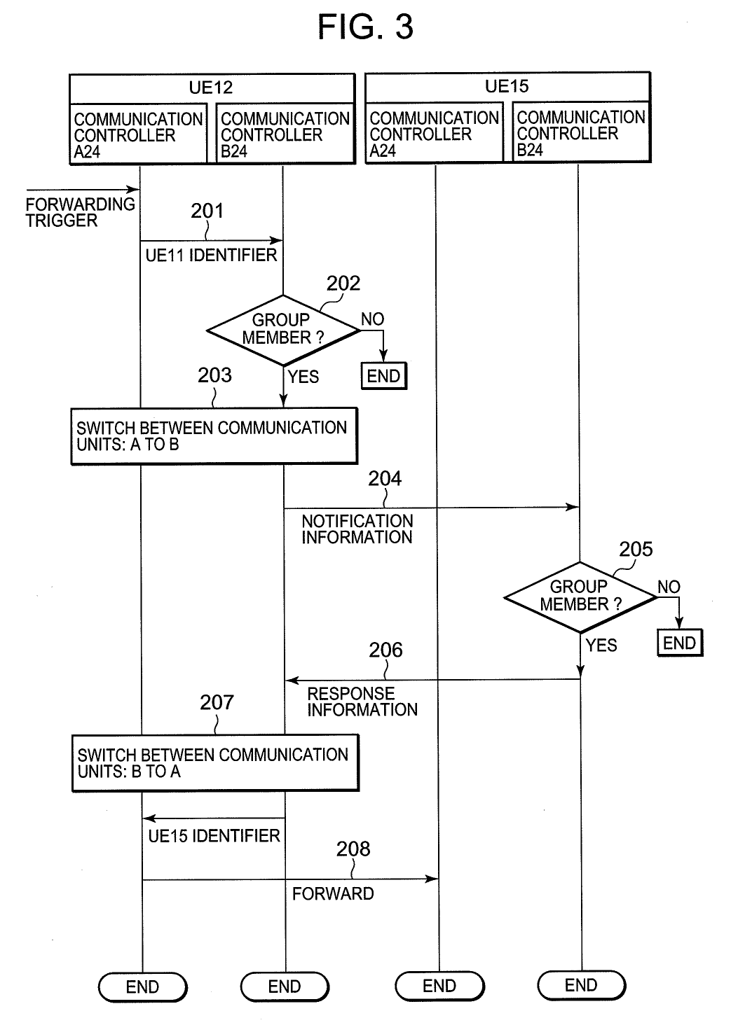

FIG. 3 is a flowchart showing operation steps performed by the cell phone according to this exemplary embodiment. FIG. 3 shows operations performed by UE12 and UE15 shown in FIG. 2.

First, the user of UE11 operates the operation unit 27 of UE11 to place a call to UE12. Upon receipt of a connection request signal from UE11 via the base station, UE12 causes the motor (not shown) to vibrate or outputs a ringing tone from the speaker 29 so as to notify the user of an incoming call. If the user of UE12 does not respond to the notification of the incoming call to UE12 or if UE12 receives a forwarding instruction from UE11, a forwarding trigger is generated. Then, the forwarding trigger is inputted into the communication controller A24. Upon input of the forwarding trigger, the communication controller A24 passes information on the terminal identifier of UE11 as call to the communication controller B24 (step 201).

Upon receipt of the information on the terminal identifier of UE11 from the communication controller A24, the communication controller B24 checks whether UE11 is included in a group member list stored in the storage unit 23 (step 202). If the communication controller B24 determines that UE11 is included in a group member list having the group identifier G1, it notifies the communication controller A24 of switching of the communication unit, and then switches the communication unit from the radio communication unit A22 to the radio communication unit B22 (step 203). Subsequently, the communication controller B24 transmits notification information including information on the group identifier G1 and the terminal identifier of UE12 to the outside via the radio communication unit B22 (step 204).

Upon receipt of the notification information from UE12, the communication controller B24 of UE15 checks whether UE12 is included in the group member list stored in the storage unit 23 (step 205). If the communication controller B24 determines that UE12 is included in a group member list having the group identifier G1, it transmits response information including information on the group identifier G1 and the terminal identifier of UE15, to UE12 (step 206).

If UE13 and UE14 shown in FIG. 2 also receive the notification information from UE12 in step 205, these terminals each check whether UE12 is included in the group member list stored in the storage unit 23. In this exemplary embodiment, it is assumed that UE13 and UE14 belong to a group different from that of UE12; therefore, none of UE13 and UE14 stores the group member list having the group identifier G1. As a result, UE13 and UE14 end the process without responding to the response request.

Upon receipt of the response information from UE15, the communication controller B24 of UE12 notifies the communication controller A24 of switching of the communication unit and then passes information on the terminal identifier of UE15 to the communication controller A24 (step 207). Then, the communication controller A24 of UE12 transmits, to the base station, the terminal identifier of UE15 and information indicating that the destination of the connection request signal will be changed to UE15, so that the connection request signal from UE11 is forwarded to UE15 (step 208).

If the user of UE15 does not answer an incoming call after step 208, UE15 and UE16 perform operation steps similar to those shown in FIG. 3 so that the connection request signal from UE11 is forwarded to UE16.

The above-described operation steps will be briefly described below.

In a cell phone network (network A shown in FIG. 2) as a radio communication network, the connection request from UE11 is transmitted to UE12 via the communication controller A24 of each terminal. If UE12, which has received an incoming call based on the connection request, does not respond to UE11, the communication unit of UE12 is switched from the radio communication unit A22 to the radio communication unit B22. Then, the communication controller B24 of UE12 searches for an UE included in the same group member list among UE located in an area (network B) where the radio communication unit B22 can communicate with other terminals. Then, in order to forward the connection request signal from UE11 to UE15 that has responded, the communication controller A24 of UE12 notifies the base station of information on the forwarding destination of the connection request signal. Thus, the connection request signal from UE11 is forwarded to UE15. If even UE15 as the forwarding destination also does not respond, UE15 searches for an UE included in the same group member list among UE in an area (network B+) where UE15 can communicate with other terminals, with the forwarding method as described above. Then, UE15 forwards the connection request signal from UE11 to UE16 that has responded.

In this exemplary embodiment, a forwarding specification field is provided in each entry of a phonebook and it is registered whether a phone number in each entry as a forwarding destination is specified or not, as described above. However, a group member list may be stored separately from the phonebook. While the group member list is stored in the storage unit 23 in the above description, the group member list may be stored in a memory (not shown) in the controller 25.

Also, in the description of FIGS. 2 and 3, assuming that there are multiple groups, the notification information includes a group identifier. However, if there is a single group, the notification information may not include information on a group identifier.

According to this exemplary embodiment, if a caller places a call to the cell phone of a person with whom the caller wants to make contact and if the person does not respond to the call, the call is forwarded to the cell phone of another person who is present within a predetermined distance from the person and belongs to the same group. As a result, the caller is allowed to leave a message for the person who cannot respond by phone with the person who can respond by phone. For example, if a person such as a driver in middle of driving a car cannot take an incoming call, the incoming call is forwarded to the cell phone of another person such as one riding in the same car. Thus, the person who can respond to the incoming call can communicate the intention of the caller to the person.

Now, a second exemplary embodiment will be described. The second exemplary embodiment is intended to, when searching for the forwarding destination of an incoming call, specify a terminal, which has responded most quickly among multiple terminals that have responded, as the forwarding destination.

Next, a configuration and operations of a cell phone according to this exemplary embodiment will be described. The configuration similar to that according to the first exemplary embodiment will not be described in detail and a portion specific to this exemplary embodiment will be described in detail.

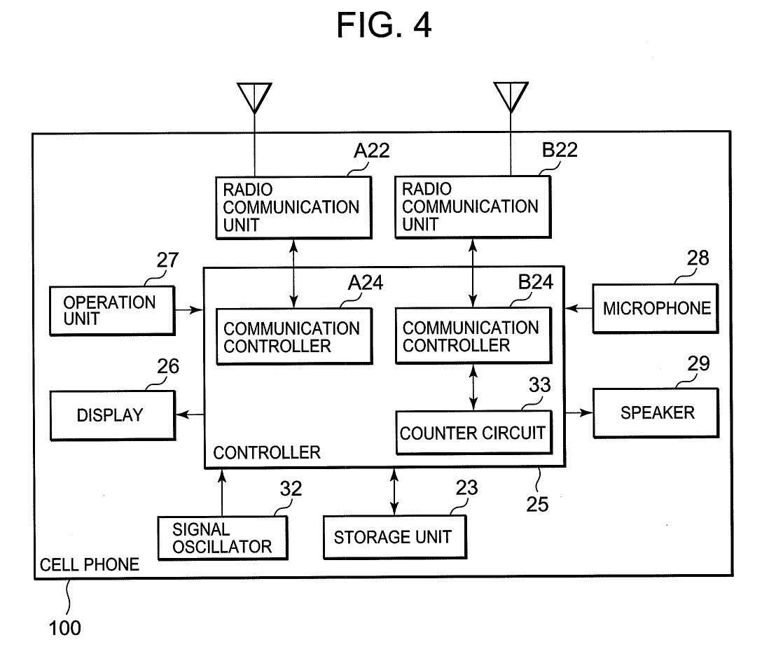

FIG. 4 is a block diagram showing an example configuration of the cell phone according to this exemplary embodiment. A cell phone 100 includes a signal oscillator 32 for generating clock signals. The controller 25 includes a counter circuit 33 for counting inputs of clock signals to measure the time.

The communication controller B24 operates the counter circuit 33 to measure the period from the time when notification information is transmitted via the radio communication unit B22 to the time when response information is received. If pieces of response information are received from multiple terminals, the communication controller B24 specifies a terminal, which has transmitted response information fastest after the transmission of the notification information, as the forwarding destination of the connection request signal.

The reason why the forwarding destination is specified in this way is that it is considered that the cell phone that has responded most quickly among the multiple cell phones that have responded is located closest to the cell phone that has transmitted the notification information. According to this exemplary embodiment, a call that a caller has placed to a person with whom the caller wants to make contact is forwarded to the cell phone of another person who is located closest to the person.

Now, a third exemplary embodiment will be described. The third exemplary embodiment is intended to, when forwarding an incoming call, prevent a terminal that has forwarded the incoming call from being specified as the destination of the connection request signal. This exemplary embodiment will be described below with reference to FIG. 2. It can be considered that when UE15 searches for the forwarding destination of the incoming call, UE15 may receive response information also from UE12 and specify UE12 as the forwarding destination of the incoming call. In this case, UE15 would forward the incoming call to UE12 that has forwarded the incoming call to UE15. This exemplary embodiment is intended to prevent such an event.

Next, a configuration and operations of a cell phone according to this exemplary embodiment will be described. The configuration similar to that according to the first exemplary embodiment will not be described in detail and a portion specific to this exemplary embodiment will be described in detail.

Notification information according to this exemplary embodiment includes a forwarding history. A specific example will be described with reference to FIG. 2. Notification information transmitted from UE15 includes a forwarding history indicating that the connection request signal has been forwarded from UE12 to UE15.

Upon receipt of notification information, the communication controller B24 stores a forwarding history included in the notification information. Subsequently, if the terminal including the communication controller B24 is specified as the forwarding destination of the connection request signal and the user does not respond, the history is updated by adding the identifier of the terminal to the stored forwarding history and notification information including the updated forwarding history is transmitted, so as to search for the forwarding destination of the connection request signal. When response information from another terminal is received, a terminal identifier is read out from the response information. And, if the terminal identifier read out is included in the forwarding history, a terminal having the terminal identifier is excluded from a candidate for forwarding destinations of the connection request signal.

Thus, according to this exemplary embodiment, a terminal that has already been selected as the forwarding destination of an incoming call is prevented from being specified again as the forwarding destination. There may be such a case where the user may be able to respond to the incoming call after a while although the user does not respond to an incoming call first. In this case, notification information may not include a forwarding history and the incoming call may be forwarded again to the terminal to which the incoming call has been forwarded. Whether the forwarding control based on a forwarding history is performed by a cell phone may be determined according to an operation of the user of a cell phone as the caller.

Next, a fourth exemplary embodiment will be described. While the first to third exemplary embodiments are intended to forward an incoming call to the terminal of a group member, this exemplary embodiment is intended to notify a group member of information on the terminal of a caller rather than forwarding an incoming call to the terminal of a group member.

A configuration and operations of a cell phone according to this exemplary embodiment will be described. The configuration similar to that according to the first exemplary embodiment will not be described in detail and a portion specific to this exemplary embodiment will be described in detail.

A cell phone according to this exemplary embodiment includes an incoming call information forwarding key (not shown) instead of the forwarding instruction key of the operation unit 27, which is mentioned in the description of the first exemplary embodiment. If this key is operated while a connection request to another cell phone is made, the communication controller A24 transmits an incoming call information forwarding signal for instructing to forward incoming call information to another cell phone, to the cell phone via the base station.

This exemplary embodiment will be described below with reference to the flowchart shown in FIG. 3. If the user does not respond to an incoming call within a predetermined time or if an incoming call information forwarding signal is received from UE11, the communication controller B24 of UE12 transmits incoming call information including the terminal identifier of UE11 as caller and information indicating that there has been an incoming call, instead of notification information, via the radio communication unit B22, in step 204.

Upon receipt of the incoming call information from UE12 in step 204, the communication controller B24 of UE15 checks whether any group member list of which group identifier corresponds to the group identifier included in the incoming call information is registered. If such a group member list exists, the communication controller B24 checks whether the terminal identifier of UE11 is included in the list. If the identifier of UE11 is registered in the list, information indicating that there has been an incoming call from UE11 is displayed on the display unit 26. On the other hand, if any group member list of which group identifier corresponds to the group identifier included in the incoming call information does not exist, or if the terminal identifier of UE11 is not included in such a list even though the list exists, the communication controller B24 ends the process without doing anything.

The user of UE15 can see the information on the incoming call from UE11 displayed on the display 26 and place a call to UE11. If a communication is established between UE11 and UE15 via the base station, the user of UE11 notifies the user of UE15 of a message for the user of UE12. The user of UE15 hangs up the phone and then communicates the message from the user of UE11 to the user of UE12.

Even if a person with whom a caller wants to make contact does not respond to an incoming call, another person who is located close to the person and belongs to the same group may call back to the caller. According to this exemplary embodiment, the caller is allowed to leave a message for the person who has not respond to the incoming call, with the another person who has called back.

Next, a fifth exemplary embodiment will be described. The fifth exemplary embodiment is intended to, if an email sender sends an email to a user of a cell phone and then wants the user to make a reply regarding the email quickly, request a person who is located close to the user to urge the user to open the email.

A configuration and operations of a cell phone according to this exemplary embodiment will be described. The configuration similar to that according to the first exemplary embodiment will not be described in detail and a portion specific to this exemplary embodiment will be described in detail.

A cell phone according to this exemplary embodiment has an email function. This email function is similar to that disclosed in Japanese Patent Application Publication NO. 2003-046663 and will not be described in detail herein. The cell phone according to this exemplary embodiment includes a message request key (not shown) instead of the forwarding instruction key of the operation unit 27 which is mentioned in the description of the first exemplary embodiment. If an email sender operates this key while a connection request to another cell is made, the communication controller A24 transmits a message request signal including the terminal identifier of the cell phone and a message requesting the opening of the email, to the cell phone as destination of the connection request, via the base station.

If the cell phone receives the message request signal while it operates to notify the user that there is an incoming call, the communication controller B24 of the cell phone checks whether the terminal identifier of the cell phone as the sender of the connection request is included in a group member list which is previously registered. If the terminal identifier is included in the group member list, the communication controller B24 transmits the message request signal via the radio communication unit B22.

Upon receipt of a message request signal via the radio communication unit B22, the communication controller B24 checks whether a terminal identifier included in the signal is included in the group member list which is previously registered. If the terminal identifier is included in the group member list, a message urging a user specified by the terminal identifier to open the email is displayed on the display 26. If the terminal identifier included in the message request signal is not included in the group member list, the communication controller B24 ends the process without doing anything.

Operations of the cell phone according to this exemplary embodiment will be described below with reference to FIG. 2.

First, the user of UE11 operates the operation unit 27 to send an email to UE12 via the base station and then places a call to UE12. If the user of UE12 does not answer the call, the user of UE11 operates the message request key of the operation unit 27 so that UE11 transmits a message request signal to UE12. When UE12 receives the message request signal from UE11, UE12 determines that UE11 is included in a group member list and then transmits the message request signal to the outside via the radio communication unit B22.

Upon receipt of the message request signal from UE12, UE15 checks whether UE11 is included in the group member list. If UE15 determines that the identifier of UE11 is included in the group member list, a message urging the user of UE12 to open an email is displayed on the display 26. Thus, the user of UE15 urges the user of UE12 to open the email.

This exemplary embodiment is advantageous in a case where an email sender sends an email including contents, which are difficult to communicate by phone, to the cell phone of another person and then places a call to the another person to notify that the email sender wants the another person to open the email soon, but the another person does not answer the call.

Instead of providing the message request key, an instruction urging the opening of an email may be provided by performing a predetermined operation on any existing key. Also, the contents of a message are not limited to those urging the opening of an email.

Any or all of the first to fifth exemplary embodiments may be combined.

As described above, the cell phones according to each of the above-described exemplary embodiments includes a first unit configured to communicate with other terminals via a base station and a second unit configured to communicate with other terminals directly. When the user does not respond to a connection request signal received via the first unit, the cell phones according to each of the above-described exemplary embodiments forward the connection request signal to another terminal that is present in the communication range of the second unit and belongs to the same group or notify another terminal of the connection request signal.

An exemplary advantage according to the invention is that if a caller places a call to a person and the person cannot respond to the call, the caller can communicate the caller's intention to the person via another person who is present close to the person who is previously registered.

While the invention has been particularly shown and described with reference to exemplary embodiments thereof, the invention is not limited to these exemplary embodiments. It will be understood by those of ordinary skill in the art that various changes in form and details may be made therein without departing from the spirit and scope of the present invention as defined by the claims.

What is claimed is:

1. A cell phone comprising:
a first communication unit configured to communicate with other cell phones via a base station;
a second communication unit configured to communicate directly with other cell phones located within a predetermined distance; and
a controller, wherein
the controller stores a list including an identifier of a candidate cell phone for a forwarding destination of a connection request signal for requesting a communication connection, and
if the controller receives the connection request signal via the first communication unit and then a user does not respond within a predetermined time or if a forwarding instruction is provided from a sender of the connection request signal, the controller conducts a search to see whether another cell phone having an identifier included in the list is located within the predetermined distance via the second communication unit, and if the controller finds the another cell phone having an identifier included in the list, the controller instructs, via the first communication unit, the base station to forward the connection request signal to the another cell phone.

2. The cell phone according to claim 1, wherein
when the controller conducts the search for the another cell phone having an identifier included in the list, the controller transmits notification information including information on an identifier of the cell phone to outside via the second communication unit, wherein, upon the receipt of response information to the notification information via the second communication unit, the controller checks whether an identifier indicating a sender of the response information is included in the list, wherein, if the identifier is included in the list, the controller specifies the another cell phone having the identifier as a transmission destination of the connection request signal.

3. The cell phone according to claim 2, wherein
information on a forwarding history of the connection request signal is included in the notification information, wherein, the controller excludes the another cell phone having an identifier included in a forwarding history from the forwarding destination of the connection request signal.

4. The cell phone according to claim 1, further comprising
a signal oscillator configured to generate a clock signal, wherein
the controller includes a counter for counting an input of the clock signal to measure a time,
the controller measures a period from a time when the notification information is transmitted to a time when the response information is received, by the counter,
if the controller receives a plurality of pieces of the response information and if identifiers indicating senders of the plurality of pieces of the response information are included in the list, the controller specifies the another cell phone identified by an identifier of a sender of a piece of the response information that the controller has received earliest, as a forwarding destination of the connection request signal.

5. The cell phone according to claim 1, wherein
if the controller receives, from a sender of the connection request signal, a message request signal including information on an identifier of the sender and a message within a predetermined time after receipt of the connection request signal via the first communication unit, the controller conduct a search, via the second communication unit, to see whether another cell phone having an identifier is located within the predetermined distance and included in the list, wherein, if the controller finds the another cell phone having the identifier included in the list, the controller forwards the message request signal to the cell phone via the second communication unit, and, upon receipt of the message request signal via the second communication unit, the controller checks whether the identifier included in the message request signal is included in the list, wherein, if the identifier is included in the list, the controller displays the message included in the message request signal on a display.

6. A cell phone comprising:
a first communication unit configured to communicate with other cell phones via a base station; and
a second communication unit configured to communicate directly with other cell phones located within a predetermined distance, wherein
a list including an identifier of a group member cell phone is stored,
if a user does not respond within a predetermined time after reception of a connection request signal for requesting a communication connection via the first communication unit or if an instruction to forward an incoming call information is provided from a sender of the connection request signal, a search, to see whether the another cell phone having the identifier included in the list is located within the predetermined distance via the second communication unit, is conducted, wherein, if the another cell phone having the identifier included in the list is found, incoming call information, including a identifier of the sender of the connection request signal, is forwarded to the another cell phone via the second communication unit, wherein, upon the receipt of the incoming call information via the second communication unit, it is checked whether an identifier included in the incoming call information is included in the list, wherein, if the identifier included in the incoming call information is included in the list, it is displayed on a display that there has been an incoming call from the another cell phone indicated by the identifier.

7. An incoming call forwarding method performed by a cell phone including a first communication unit configured to communicate with other cell phones via a base station and a second communication unit configured to communicate directly with other cell phones located within a predetermined distance, the method comprising:
a) storing a list including an identifier of a candidate cell phone for a forwarding destination of a connection request signal for requesting a communication connection;
b) conducting a search to see whether another cell phone having an identifier included in the list is located within the predetermined distance via the second communication unit, if a user does not respond within a predetermined time after reception of the connection request signal via the first communication unit or if an instruction to forward is provided from a sender of the connection request signal; and
c) instructing the base station, via the first communication unit, to forward the connection request signal to the another cell phone, if a cell phone having the identifier included in the list is found.

8. The incoming call forwarding method according to claim 7, wherein
transmitting notification information including information on an identifier of the cell phone, to outside via the second communication unit, when a search to see the another cell phone having the identifier included in the list is conducted,
checking whether an identifier indicating a sender of the response information is included in the list, upon receipt of response information to the notification information via the second communication unit, and
specifying the another cell phone having the identifier as a transmission destination of the connection request signal, if the identifier indicating the sender of the response information is included in the list.
